(19) United States
(12) Patent Application Publication
(10) Pub. No.: US 2008/0122965 A1
(43) Pub. Date: May 29, 2008

(54) PORTABLE COMPUTER APPARATUS

(75) Inventor: Tzu-Hao Fang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/872,724

(22) Filed: Oct. 16, 2007

(30) Foreign Application Priority Data
Nov. 27, 2006 (TW) 95143698

(51) Int. Cl. H04N 5/222

(52) U.S. Cl. 348/333.06; 348/E05.022

(57) ABSTRACT

A portable computer is disclosed, which includes a host, a display, an image capturing module and a biaxial rotating structure. The host is used for processing digital data. The display is used for displaying the result of processing digital data. The image capturing module is pivoted on a frame of the display by the biaxial rotating structure, such that the image capturing module may rotate horizontally or vertically relative to the display, thus increasing the viewing angle of the image capturing module.

### CROSS-REFERENCE TO RELATED APPLICATION

This application claims the priority benefit of Taiwan application serial no. 95143698, filed on Nov. 27, 2006. All disclosure of the Taiwan application is incorporated herein by reference.

### BACKGROUND OF THE INVENTION

1. Field of the Invention

The invention relates to a portable computer apparatus and, more particularly, to a portable computer apparatus having an image capturing module which can rotate horizontally or vertically.

2. Description of the Related Art

With the development of the science and technology, portable computer apparatuses such as notebooks have gradually replaced the desktop computers. Nowadays, some of medium or high level portable computer apparatuses are often equipped with an image capturing module (or called web camera) to enable users to interact with remote users or to record personal images by the image capturing module.

FIG. 1 is a three-dimensional schematic diagram showing a conventional notebook having an image capturing module. Refer to FIG. 1. A notebook 100 includes a host 110 and a display 120 pivotally connected to one side of the host 110. Generally speaking, an image capturing module 130 is provided on the display 120 of the notebook 100 to capture images of users in a video conference. The image capturing module 130 includes an image capturing apparatus 132 and a pivotal mechanism 134. The image capturing apparatus 132 is pivotally provided on the display 120 by the pivotal mechanism 134, and the image capturing apparatus 132 can rotate vertically along the rotating axis A relatively to the notebook 100 via the pivotal mechanism 134.

However, during a video conference, if a group of people discuss around the front of the notebook 100, since the view angle of the image capturing apparatus 132 is narrow, the image capturing apparatus 132 only can capture the image of users in front of it. When images of users in other positions should be captured, the position of the notebook 100 should be moved to capture the images. Moreover, when the image capturing apparatus 132 is turned 180 degrees to capture the images of users facing the LCD housing of the notebook 100, the image captured by the image capturing apparatus 132 will be reversed. Therefore, a switch device is needed to process the reversed image.

In addition, the space of the notebook 100 is limited. To reduce the size of the parts in the notebook 100, the size of the image capturing module 130 will not be much large, which will make the image capturing module 130 rotate unfluently in operation.

### BRIEF SUMMARY OF THE INVENTION

One objective of the invention is to provide a portable computer apparatus to solve the problem in the conventional technology.

To obtain the above objective, the invention provides a portable computer apparatus including a host, a display, an image capturing module and a biaxial rotating structure. The host is used to process digital data. The display is used to show the processing result of the digital data, wherein one side of the display is pivotally connected to one side of the host to enable the display to open or close relatively to the host. The image capturing module is provided on the display and includes a housing and an image capturing apparatus provided in the housing. The biaxial rotating structure includes a first pivot group and at least one second pivot group. The first pivot group includes a first pivoting part and a second pivoting part. The first pivoting part is provided on the housing of the image capturing module, and the second pivoting part is fixed on the display. The first pivoting part is able to drive the image capturing module to rotate along a first rotating axial relatively to the second pivoting part. The second pivot group includes a third pivoting part and a fourth pivoting part. The third pivoting part is fixed on the first pivoting part, and the fourth pivoting part is fixed on the housing of the image capturing module. The fourth pivoting part is able to drive the image capturing module to rotate along a second rotating axial relatively to the third pivoting part.

To obtain the above objective, the invention provides another portable computer apparatus including a host, a display, an image capturing module, and a biaxial rotating structure. The host is used to process digital data. The display is used to show the processing result of the digital data. One side of the display is pivotally connected to one side of the host to enable the display to open or close relatively to the host. The image capturing module is provided on the display and includes a housing and an image capturing apparatus provided in the housing. The biaxial rotating structure includes a first pivot group and at least one second pivot group. The first pivot group is assembled between the housing of the image capturing module and the display to enable the image capturing module to rotate along a first rotating axial relatively to the display. The at least one second pivot group is assembled on the first pivot group and the housing of the image capturing module to enable the image capturing module to rotate along a second rotating axial.

In one embodiment of the invention, the fourth pivoting part is fixed on the housing of the image capturing module by locking or sticking.

In one embodiment of the invention, the number of the second pivot group can be two, and the second pivot groups can be provided on the two sides of the first pivot group.

In one embodiment of the invention, the third pivoting part of each of the second pivot groups includes an L shape block and a pivoting portion. The L shape block has a first end and a corresponding second end. The first end is fixed on the first pivoting part, and the pivoting portion is assembled on the second end.

In one embodiment of the invention, the first pivoting part and the second pivoting part are formed by the combination of a shaft and a bush.

In one embodiment of the invention, the third pivoting part and the fourth pivoting part are formed by the combination of a shaft and a bush.

In one embodiment of the invention, the portable computer apparatus can be a notebook, a tablet personal computer (tablet PC), a palmtop computer or an ultra-mobile personal computer (UMPC).

### Beneficial Effect:

The portable computer of the invention enables the image capturing module to rotate horizontally or vertically relatively to the display by a biaxial rotating structure. Thus, during a video conference, if an image of a user in other position should be captured, the image capturing module can be rotated horizontally or vertically to aim at the user who is speaking, so that the view angle can be enlarged.

In addition, since the image capturing module can rotate horizontally, when the image capturing module rotates 180 degrees to capture the image of a user facing the LCD housing of the portable computer, the captured image is a normal image instead of a reversed image. Thus, a switch device is not needed to process the reversed image.

These and other features, aspects, and advantages of the present invention will become better understood with regard to the following description, appended claims, and accompanying drawings.

### BRIEF DESCRIPTION OF THE DRAWINGS

FIG. 1 is a three-dimensional schematic diagram showing a conventional notebook having an image capturing module.

FIG. 2 is a three-dimensional schematic diagram showing a portable computer apparatus of one embodiment of the invention.

FIG. 3 is a three-dimensional schematic diagram showing the image capturing module and the biaxial rotating structure provided at the lower part thereof shown in FIG. 2.

FIG. 4 is a three-dimensional schematic diagram showing the biaxial rotating structure shown in FIG. 3.

FIG. 5 is a three-dimensional schematic diagram showing an image capturing module and a biaxial rotating structure of another embodiment of the invention.

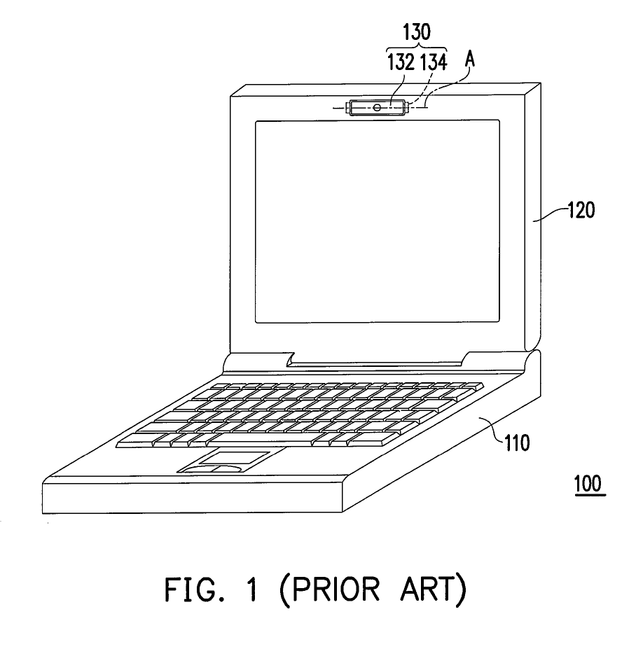

### DETAILED DESCRIPTION OF THE EMBODIMENTS

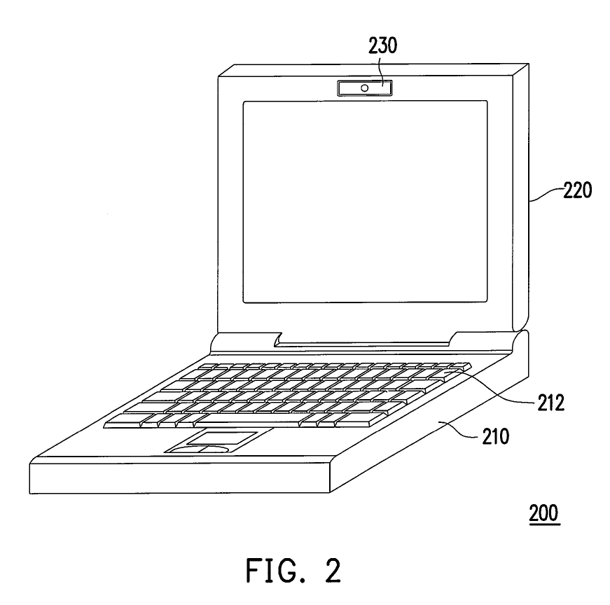

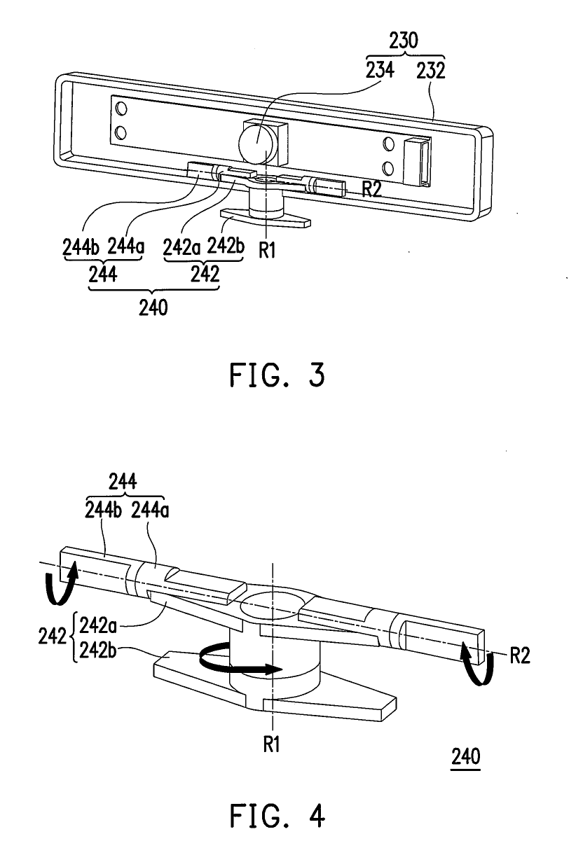

FIG. 2 is a three-dimensional schematic diagram showing a portable computer apparatus of one embodiment of the invention. FIG. 3 is a three-dimensional schematic diagram showing the image capturing module and the biaxial rotating structure provided at the lower part thereof shown in FIG. 2. FIG. 4 is a three-dimensional schematic diagram showing the biaxial rotating structure shown in FIG. 3. To simplify the FIG. 3, the FIG. 3 only shows the image capturing module and the biaxial rotating structure. Refer to FIG. 2, FIG. 3, and FIG. 4 simultaneously. The portable computer apparatus 200 includes a host 210, a display 220, an image capturing module 230, and a biaxial rotating structure 240.

In this embodiment, the portable computer apparatus 200 is a notebook. In other embodiments, the portable computer apparatus 200 may be a tablet personal computer (tablet PC), a palmtop computer, or an ultra-mobile personal computer (UMPC), and there is no limitation thereon. Moreover, in this embodiment, the image capturing module 230 is a web camera to capture the image of users in a video conference.

The host 210 is a main part for processing digital data in the whole portable computer apparatus 200. For example, when users process a file or make an engineering drawing by some graphics software, the application program executed by the users or the operation of all digital data in function options is processed by the host 210. A keyboard 212 is provided on the host 210 to enable users to input needed data or to execute some specific functions. The display 220 such as a liquid crystal display (LCD) shows the processing result of the digital data operated by the host 210 to make users know the result of the executed application program or function options. As shown in FIG. 2, one side of the display 220 is pivotally connected to one side of the host 210 to enable the display 220 to open or close relatively to the host 210.

The image capturing module 230 is installed on the display 220 and can rotate horizontally or vertically relatively to the display 220 by the biaxial rotating structure 240. Thus, during a video conference, users can rotate the image capturing module 230 horizontally or vertically to capture the needed image.

As shown in FIG. 3, the image capturing module 230 includes a housing 232 and an image capturing apparatus 234 provided in the housing 232. The image capturing apparatus 234 includes an optical sensor, such as a CMOS sensor, a lens, and so on, to capture images and process signals.

The biaxial rotating structure 240 is assembled in the housing 232 of the image capturing module 230 which includes a first pivot group 242 and at least a second pivot group 244. Please refer to FIG. 2 and FIG. 3. The first pivot group 242 is assembled between the housing 232 of the image capturing module 230 and the display 220, so that the image capturing module 230 can rotate along a first rotating axial R1 relatively to the display 220. The at least one second pivot group 244 is fixed on the first pivot group 242 and the housing 232 of the image capturing module 230, so that the image capturing module 230 can rotate along a second rotating axial R2. In this embodiment, the second pivot groups 244 are fixed at the two sides of the first pivot group 242, respectively. However, if the biaxial rotating structure 240 only includes a set of second pivot group 244, the function of rotating vertically of the image capturing module 230 also can be obtained. The following describes the detailed structure of the first pivot group 242 and the at least one pivot group 244 and the connecting relationship thereof further.

In this embodiment, the first pivot group 242 includes a first pivoting part 242a and a second pivoting part 242b. The first pivoting part 242a is partly provided in the housing 232 of the image capturing module 230, and the second pivoting part 242b is fixed on the display 220 (Please refer to FIG. 2 simultaneously.). The first pivoting part 242a is suitable to drive the whole image capturing module 230 to rotate along the first rotating axial R1 relatively to the second pivoting part 242b. In one embodiment of the invention, the first pivoting part 242a and the second pivoting part 242b are formed by the combination of a shaft and a bush to enable the first pivoting part 242a to rotate relatively to the second pivoting part 242b.

The second pivot group 244 includes a third pivoting part 244a and a fourth pivoting part 244b. The third pivoting part 244a is fixed on the first pivoting part 242a, and the fourth pivoting part 244b is fixed on the housing 232 of the image capturing module 230. In other embodiment, the third pivoting part 244a also can be an extending portion of the first pivoting part 242a. That is, the third pivoting part 244a and the first pivoting part 242a can be integrally formed.

The fourth pivoting part 244b is suitable to drive the whole image capturing module 230 to rotate along the second rotating axial R2 relatively to the third pivoting part 244a. The first rotating axial R1 is perpendicular to the second rotating axial R2 substantially. Similarly, the third pivoting part 244a and the fourth pivoting part 244b can be formed by the combination of a shaft and a bush, so that the fourth pivoting part 244b can rotate relatively to the third pivoting part 244a. In this embodiment, the fourth pivoting part 244b is fixed on the housing 232 by locking or sticking. Thus, when the fourth pivoting part 244b rotates, it will drive the whole housing 232 to rotate.

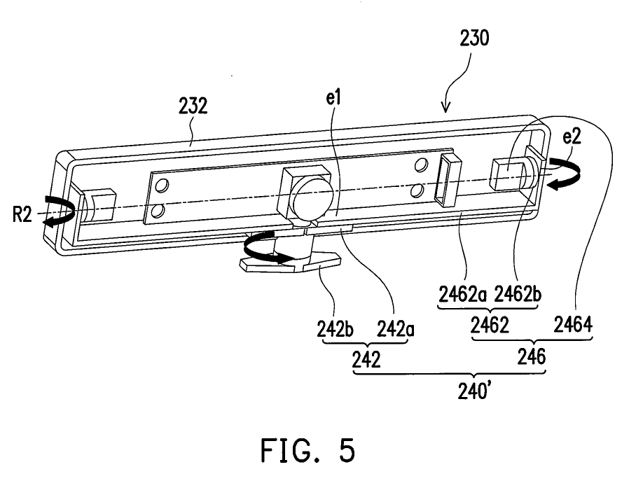

FIG. 5 is a three-dimensional schematic diagram showing an image capturing module and a biaxial rotating structure of another embodiment of the invention. To simplify the FIG. 5, the FIG. 5 only shows the image capturing module and the biaxial rotating structure provided at the lower part thereof. Please refer to FIG. 5. The biaxial rotating structure 240′ is roughly similar to the biaxial rotating structure 240 shown in FIG. 4. However, second pivot group 246 of the biaxial rotating structure 240′ shown in FIG. 5 is slightly different from that of the above embodiment, wherein the second pivot group 246 includes a third pivoting part 2462 and a fourth pivoting part 2464.

The third pivoting part 2462 includes an L shape block 2462a and a pivoting portion 2462b. The L shape block 2462a has a first end e1 and a corresponding end e2. The first end e1 is fixed on the first pivoting part 242a, and the second end e2 is formed by the extending portion of the first end e1. The second end e2 is perpendicular to the first end e1. The pivoting portion 2462b is assembled on the second end e2 by riveting or sticking.

The fourth pivoting part 2464 of the second pivot group 246 is also fixed on the housing 232 of the image capturing module 230 by locking or sticking. The fourth pivoting part 2464 is pivotally connected to the third pivoting part 2462, so that the whole housing 232 of the image capturing module 230 can rotate relatively to the pivoting portion 2462b of the third pivoting part 2462 to enable the image capturing module 230 to rotate along the second rotating axial R2.

To sum up, the portable computer apparatus of the preferred embodiment of the invention can enable the image capturing module installed in the display to rotate horizontally or vertically relatively to the display by the biaxial rotating structure. Thus, during a video conference, if an image of a user in other position should be captured, the image capturing module can be rotated horizontally or vertically to face the user who is speaking to enlarge the angle of view.

In addition, since the image capturing module can rotate horizontally, when the image capturing module rotates backward 180 degrees to capture the image of a user facing the outer housing of the portable computer apparatus, the captured image is a normal image instead of a reversed image. Thus, a switch apparatus is not needed to process the reversed image.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable computer apparatus comprising:
a host;
a display pivotally connected to one side of the host to enable the display to open or close relatively to the host;
an image capturing module provided on the display and comprising a housing and an image capturing apparatus provided in the housing; and
a biaxial rotating structure comprising a first pivot group and at least one second pivot group,
wherein the first pivot group comprises a first pivoting part provided on the housing of the image capturing module and a second pivoting part fixed on the display, and the first pivoting part is suitable to drive the image capturing module to rotate along a first rotating axial relatively to the second pivoting part,
wherein the second pivot group comprises a third pivoting part fixed on the first pivoting part and a fourth pivoting part fixed on the housing of the image capturing module, and the fourth pivoting part is suitable to drive the image capturing module to rotate along a second rotating axial relatively to the third pivoting part.

2. The portable computer apparatus according to claim 1, wherein the fourth pivoting part is fixed on the housing of the image capturing module by locking or sticking.

3. The portable computer apparatus according to claim 1, wherein the number of the second pivot group is two, and the second pivot groups are provided at the two sides of the first pivot group, respectively.

4. The portable computer apparatus according to claim 1, wherein the third pivoting part of each of the second pivot groups comprises an L shape block and a pivoting portion, and the L shape block has a first end fixed on the first pivoting part and a corresponding second end, and the pivoting portion is assemble on the second end.

5. The portable computer apparatus according to claim 1, wherein the first pivoting part and the second pivoting part are formed by the combination of a shaft and a bush.

6. The portable computer apparatus according to claim 1, wherein the third pivoting part and the fourth pivoting part are formed by the combination of a shaft and a bush.

7. The portable computer apparatus according to claim 1, wherein the portable computer apparatus is a notebook, a tablet personal computer (tablet PC), a palmtop computer or an ultra-mobile personal computer (UMPC)

8. A portable computer apparatus comprising:
a host;
a display pivotally connected to one side of the host to enable the display to open or close relatively to the host;
an image capturing module provided on the display and comprising a housing and an image capturing apparatus provided in the housing; and
a biaxial rotating structure comprising a first pivot group and at least one second pivot group,
wherein the first pivot group is assembled between the housing of the image capturing module and the display to enable the image capturing module to rotate along a first rotating axial relatively to the display, and the at least one second pivot group is assembled on the first pivot group and the housing of the image capturing module to enable the image capturing module to rotate along a second rotating axial.

9. The portable computer apparatus according to claim 8, wherein the portable computer apparatus is a notebook, a tablet personal computer (tablet PC), a palmtop computer, or an ultra-mobile personal computer (UMPC).
